(19) United States
(12) Patent Application Publication
(10) Pub. No.: US 2008/0041998 A1
(43) Pub. Date: Feb. 21, 2008

(54) Material processor apparatus and method for recycling construction and demolition waste

(76) Inventor: Terrence E. Gillis, Tacoma, WA (US)

Correspondence Address: LAW OFFICES;WILLIAM FORSTER, P.O. BOX 2480, SHELTON, WA, 98584, US

(21) Appl. No.: 11/729,763

(22) Filed: Mar. 28, 2007

Related U.S. Application Data
(60) Provisional application No. 60/787,121, filed on Mar. 28, 2006.

(51) Int. Cl. B02C 18/08

(52) U.S. Cl. 241/282.1

(57) ABSTRACT

A material processor for cutting, breaking down and shredding waste construction materials to produce fibrous media for recycling. The material processor includes a drum housing with a top feed opening through which waste materials can pass through and into the drum housing, and a bottom exit opening through which processed waste material can exit. Two vertically oriented, spaced blade columns mounted within the drum housing. Each blade column having vertically spaced planar blades supported in stacked relationship, the individual blades being supported at one end thereof at a predetermined, fixed elevation and position to lie in a horizontal plane. The blade columns being arranged to define a cutting zone between their respective vertical axes where the blades of one blade column overlap the blades of the adjacent blade column. Each blade column being driven by a drive mechanism arranged and engaged to rotate the first and second blade columns about their respective vertical axes in the same rotational direction.

This application claims the benefit of U.S. Provisional Application No. 60/787,121 filed Mar. 28, 2006.

### BACKGROUND

This invention relates generally to machines that break-down waste materials into small particles, and more particularly to machines that process and recycle dense construction and demolition waste materials that vary widely in moisture content.

Machines that process material for recycling are known in the art. Typically, most such machines are directed to processes that either crush or grind material into small particles. One problem many designs have in common is that they are poorly suited for processing waste materials that retain a high moisture content like those usually encountered in construction and demolition materials. One characteristic of high moisture content materials is that in the grinding or crushing process, sticky compounds are produced that create a paste that will not pass through conventional processing equipment.

For example in April 1975, U.S. Pat. No. 3,878,995 issued disclosing a refuse shredder comprising two counter-rotating blade assemblies having closely spaced blades with multiple joints in each blade. This design arranges the blade assemblies to rotate about a horizontal axis. With this configuration, moist construction materials would tend to be pulled through the apparatus by the spinning blades. This action would likely result in incomplete shredding, as well as jamming the apparatus.

Other examples are U.S. Pat. No. 5,240,188 issued in August 1993, that discloses a mulching machine having closely spaced blades mounted on horizontal shafts that spin in a counter-rotating pattern. Because of blade spacing, and the spin pattern, porous wet materials would likely clog this type of mulcher.

Similarly, U.S. Pat. No. 5,248,100 issued in September 1993, and U.S. Pat. No. 5,680,999 issued in October 1997 illustrate a crusher having horizontally disposed, counter-rotating blade assemblies where the blades of one shaft nearly contact the blades of an opposing shaft. Accordingly, moist waste construction materials have the potential to become wedged between the blades thereby clogging the crusher.

In addition, 9 U.S. patents were issued to inventor Irwin between 1987 and 2004 that illustrate similar designs where waste comminuting machines are provided to reduce waste materials, such as plastic sheet material, into progressively smaller pieces. These designs share common features similar to those cited above, namely spaced-apart blade assemblies that spin in counter-rotating movement about horizontal axes where the individual blades are disposed very close together. Accordingly, these designs would also likely be ineffective at shredding moist, dense construction materials.

Accordingly a need remains for a cost effective and simple mechanical design to effectively process construction and demolition waste materials into a useful product that is environmentally safe.

### SUMMARY

One object of the invention is to recycle construction and demolition waste.

A second object of the invention is to turn waste constructions materials into a useful and valuable product.

Another Object is to safely clean-up and eliminate construction waste debris that would otherwise be detrimental to the environment.

Yet another object is to form a central depository for the collection of construction waste debris for safe disposal thereof.

A further object of the invention is to cost effectively collect and process construction waste debris.

Still another object is to reduce the burden on land-fills by recycling construction and demolition waste materials.

The invention is a material processor for cutting, breaking down and shredding waste construction materials to produce fibrous media for recycling the same. As will be noted in the following specification, the material processor is directed to multiple columns of blades spaced-apart, and spinning with a rotation that creates a cutting zone between the blade columns.

In the present invention, a drum housing is provided to contain and support the internal cutting parts. The drum housing includes a top feed opening through which waste materials can pass through, into the drum housing. Similarly, a bottom exit opening is provided so that processed waste material can exit and be collected.

Two blade columns are contained within the drum housing: a first blade column of vertically spaced planar blades supported in stacked relationship, each blade being supported at a supported end thereof, at a predetermined, fixed elevation and position, to lie in a horizontal plane. Similarly, a second, similarly constructed blade column is horizontally spaced apart from the first blade column.

Each first and second blade columns comprise common components including a vertically oriented shaft positioned to define a vertical axis. In addition, a plurality of blade assemblies are provided and include a blade hub and at least one set of planar blades. Moreover, each blade hub defines a centrally located bore provided to enable co-axial mounting of each individual blade hub on the respective shaft, in vertical spaced relationship. Each blade hub includes a substantially horizontal mounting surface disposed about the centrally located bore, with each blade having its supported end mounted to the mounting surface, wherein the blades extend outward from the blade hub.

Beyond this, a plurality of spacer members are provided wherein each spacer member is symmetrically formed to define a bore provided to enable co-axial mounting of the individual spacer members on a respective shaft so that each blade assembly is separated by at least one spacer member.

In order to maintain the blade assemblies, and spacer members in a predetermined fixed order and position on the each respective shaft, a threaded member, i.e., threaded means is arranged to threadedly engage a threaded portion of the shaft to urge the blade assemblies and spacers together. Additionally, the blades of the first blade column are maintained at an elevation offset from the blades of the second column to accommodate rotation of the blade columns without interference.

Importantly, the vertical axis of the first blade column is horizontally spaced apart from the vertical axis of the second blade column to define a vertical plane disposed between the blade columns. The blade columns are spaced so that the blades of the first blade column horizontally overlap the blades of the second blade column to create a cutting zone disposed between the first and second blade columns as a drive mechanism drives the blade columns to rotate about their respective axes.

The foregoing and other objects, features, and advantages of this invention will become more readily apparent from the following detailed description of a preferred embodiment which proceeds with reference to the accompanying drawings, wherein the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a perspective view of the exterior of a material processor having inspection doors provided to view the internal blade columns and assemblies thereof.

FIG. 2 is an elevational cross-section taken through the material processor to expose the internal blade columns and their relative spaced-apart position to illustrate the overlapping blades thereof.

FIG. 3 is a cross-section taken along 3-3 to show the vertically oriented shaft of a blade column having blade assemblies being separated by spacer members with the top spacer having a counterbore disposed to accommodate a nut that threadedly engages the shaft.

FIG. 3A is a partial cross-section similar to FIG. 3, with the top spacer being threaded to threadedly engage the shaft.

FIG. 4 is a plan view of a material processor with portions of the top cover omitted to illustrate the relative rotation of the two blade columns.

FIG. 5 is a plan view of a material processor with portions of the top cover omitted to illustrate the rotation of the two blade columns, and the leading edge of the blades of the first column which move in a direction counter to the direction of the leading edge of the blades of the second column, in the cutting zone, so that as material falls between the first and second column, the material comes in contact with blades traveling in opposing directions.

FIG. 6 is a plan view of a material processor with portions of the top cover omitted to illustrate the rotation of the two blade columns with the blades of the first blade column aligned with blades of the second blade column in the cutting zone.

FIG. 7 is a partial exploded perspective view illustrating a shaft extending through the bore of two blade assemblies, oriented at 90 degrees relative rotation, separated by spacers similarly co-axially received on the shaft.

FIG. 8 is a perspective view of a blade column supported at the top and bottom by bearings held in place by the material processor structure, with a belt pulley engaging a belt to rotationally drive the blade column in a specific direction.

FIG. 9 is a perspective view of a first and second blade column, each supported at the top and bottom by bearings held in place by the material processor structure, with a belt pulley on each blade column engaging a belt to rotationally drive the blade columns in the same rotational direction, wherein blades from the first blade column are aligned with blades from the a second blade column in the cutting zone disposed between the first and second blade columns.

FIG. 10 is a partial perspective view showing an alternative blade construction where the planar blades extend outward from the blade assembly with the blade tips having an expanded width.

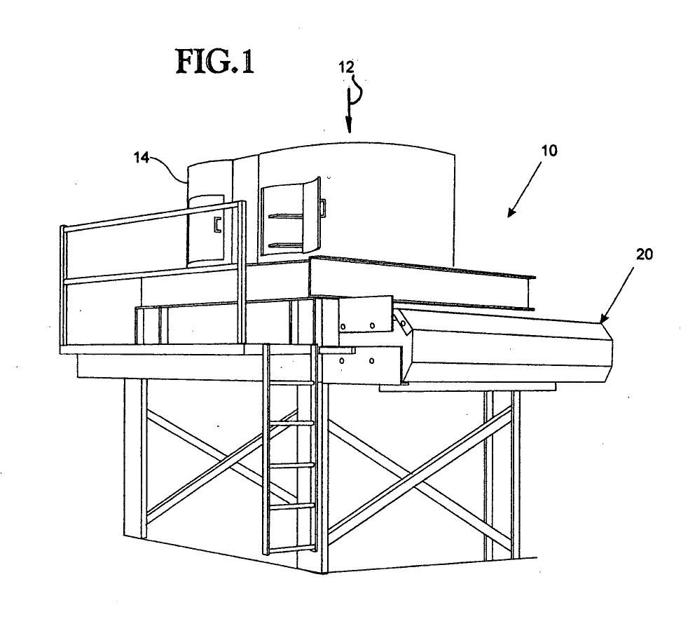

### DETAILED DESCRIPTION OF PREFERRED EMBODIMENT

Indicated generally at 10 is a material processor for cutting, breaking down and shredding waste construction materials, indicated by arrow 12, to produce fibrous media for recycling the same. In the present invention, a drum housing 14 is provided to contain and support the internal cutting parts as described in detail below. The drum housing 14 is constructed to form a top feed opening 16 through which waste materials can pass through, into the drum housing 14. Similarly, a bottom exit opening 18 is provided so that processed waste material can exit on to a conveyor mechanism 20 to be either redirected through the material processor 10, or to a stock pile (not illustrated) of material ready for use.

Importantly, two blade columns are contained within the drum housing 14. For example, a first blade column 22 of vertically spaced planar blades 24 are supported in stacked relationship, each blade 24 being supported at a supported end 28 thereof at a predetermined, fixed elevation and position to lie in a horizontal plane, and an unsupported free end 30. Similarly, a second blade column 32, is horizontally spaced apart from the first blade column 22, and includes vertically spaced planar blades 24 supported in stacked relationship, with each blade having a supported end 28 that is supported at a predetermined, fixed elevation and position to lie in a horizontal plane, and an unsupported free end 30.

Further, in the present invention, each first and second blade columns 22-32 comprise common components. Specifically, a vertically oriented shaft 34 is positioned to define a vertical axis 36. In addition, a plurality of blade assemblies 38 are provided and include a blade hub 40 and at least one set of planar blades 24. Moreover, each blade hub 40 defines a centrally located bore 42 provided to enable co-axial mounting of each individual blade hub 40 on the respective shaft 34, in vertical spaced relationship. Also, each blade hub 40 includes a substantially horizontal mounting surface 44 disposed about the centrally located bore 42, with each blade 24 having its supported end 28 mounted to the mounting surface 44, wherein the blades 24 extend outward from the blade hub 40, and are disposed so that the horizontal center of gravity of the blade assembly 38 lies substantially at the axis 36 of the shaft 34.

Beyond this, a plurality of spacer members 46 are provided wherein each spacer member 46 is symmetrically formed to define a bore 48 provided to enable co-axial mounting of the individual spacer members 46 on a respective shaft 34 so that each blade assembly 38 is separated by at least one spacer member 46.

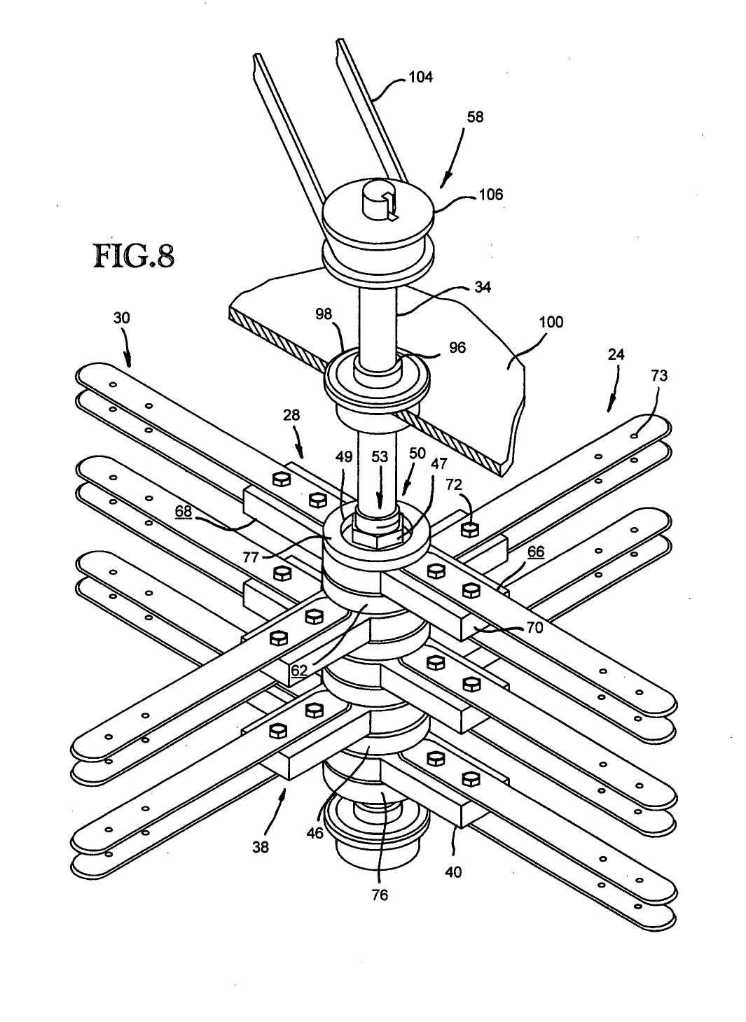

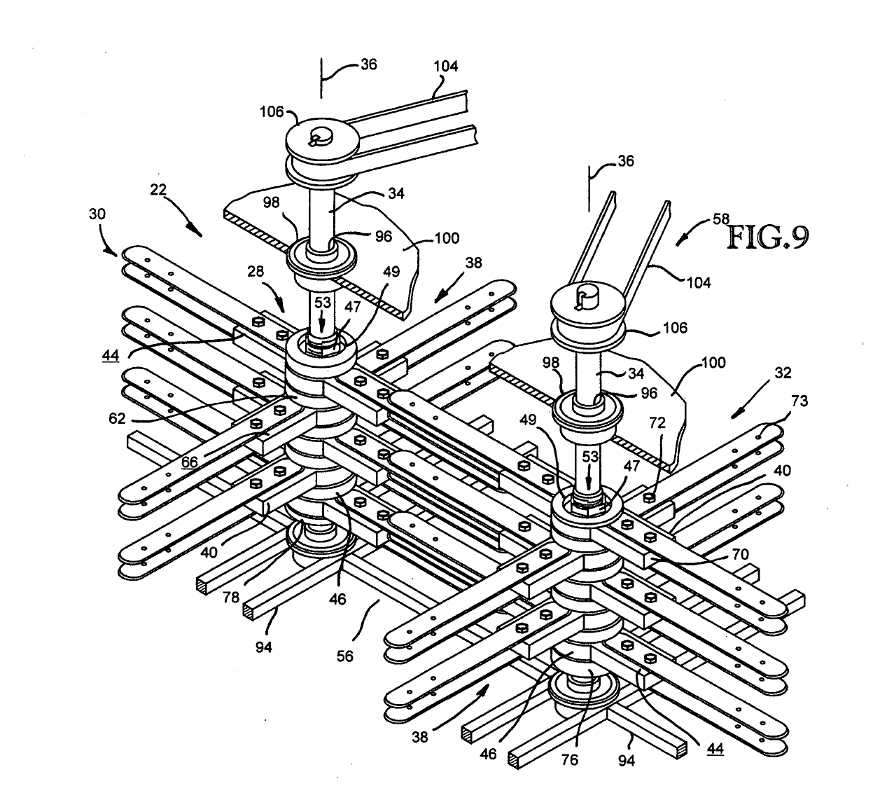

In order to maintain the blade assemblies 38, and spacer members 46 in a predetermined fixed order and position on the each respective shaft 34, a threaded member 50, i.e., “threaded means” is arranged to threadedly engage a threaded portion 53 of the shaft 34. In this way, the blade assemblies 38 and spacer members 46 can be urged together with tightening of a nut 47 as illustrated in FIG. 8. Also illustrated, is a counterbore 49 formed in the top spacer member to accommodate the nut 47 so that each shaft can be manufactured alike.

Additionally, the blades 24 of the first blade column 22 are maintained at an elevation offset from the blades of the second column 32. As will be explained more fully below, this offset allows the blades 24 of the first and second blade columns 22, 32 to pass without interference form each other.

As can be seen in the illustrations, the vertical axis 36 of the first blade column 22 is horizontally spaced apart from the vertical axis 36 of the second blade column 32 to define a vertical plane disposed between the blade columns where the blades 24 of the first blade column 22 horizontally overlap the blades 24 of the second blade column 32 to create a cutting zone 56 disposed between the first and second blade columns 22, 32 as the blade columns rotate about their respective axes.

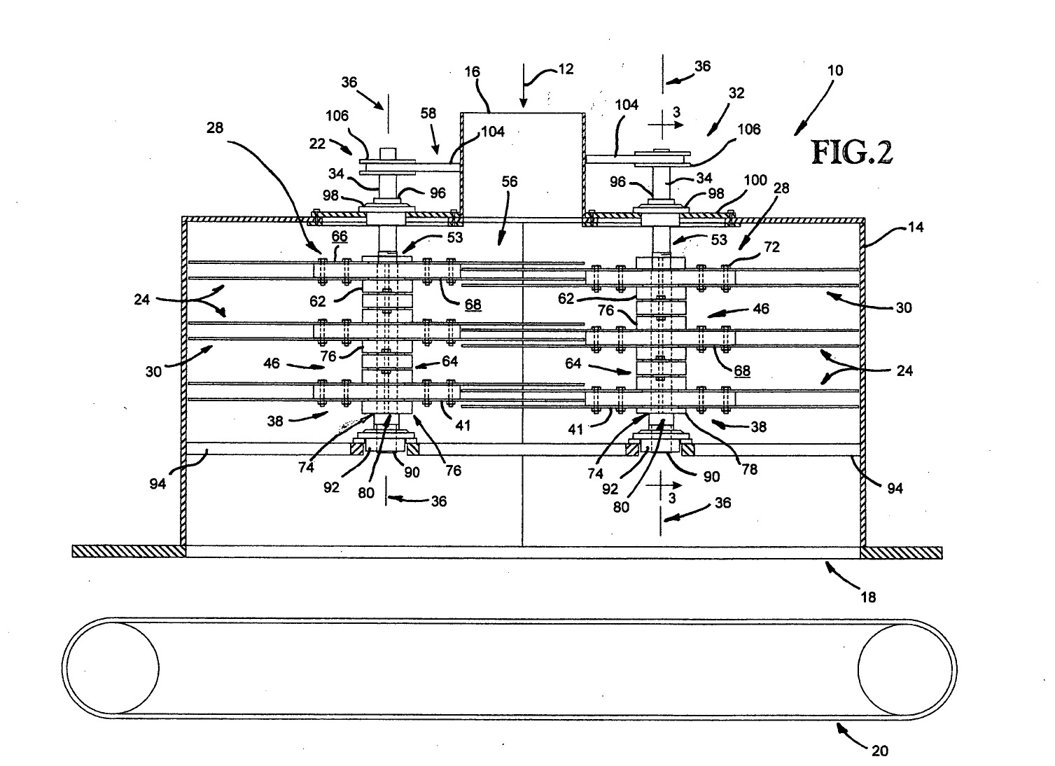

Importantly, a drive mechanism 58 is arranged and engaged to rotate the first and second blade columns 22, 32 about their respective vertical axes in the same rotational direction thereby causing the leading edge 60 of the blades 24 of the first blade column 22 to move or rotate in a direction counter to the direction of the leading edge 60 of the blades 24 of the second blade column 32 so that as waste material falls between the first and second blade columns 22, 32 (see arrow 12 in FIG. 2), the material comes in contact with blades traveling in opposing directions. Accordingly, this blade action from the first and second blade columns 22, 32 creates the cutting zone 56 where the waste material is broken down and shredded to produce the fibrous media for recycling.

Considering now in more detail, the components from which a material processor is constructed, one embodiment of the present invention includes three spacer members 46 disposed between each blade assembly 38. Specifically, one large diameter spacer member 62, having a thick profile, is sandwiched by two reduced diameter spacer members 64, which have a thin profile to compensate for the thickness of a adjacent planar blade 24.

As can be seen, the reduced diameter spacer members 64 have a thickness slightly greater than the thickness of a blades 24 to prevent any one blade from contacting an adjacent spacer member 46. It should be noted, however, that other spacer arrangements could be employed. For example, the large diameter spacer members 64 could be reduced in number or even eliminated all together without significantly effecting the performance of the material processor 10.

Another alternate embodiment of the present invention comprises a blade hub arrangement where each blade hub 40 defines an upper mounting surface 66, for receiving a set of blades 24, and a lower mounting surface 68 disposed to receive a second set of blades 24, wherein the centrally located bore 42 extends from the upper mounting surface 66 to the lower mounting surface 68. In this way, each blade hub 40 can support twice as many blades 24 as opposed to a design where only one surface can be used to support blades 24.

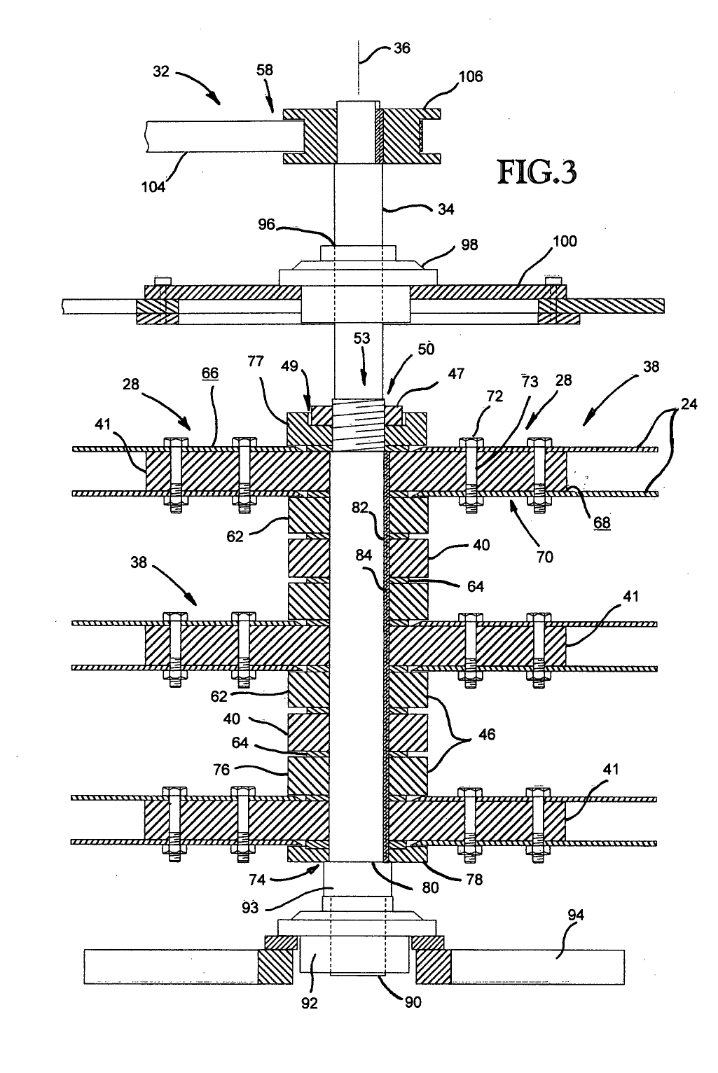

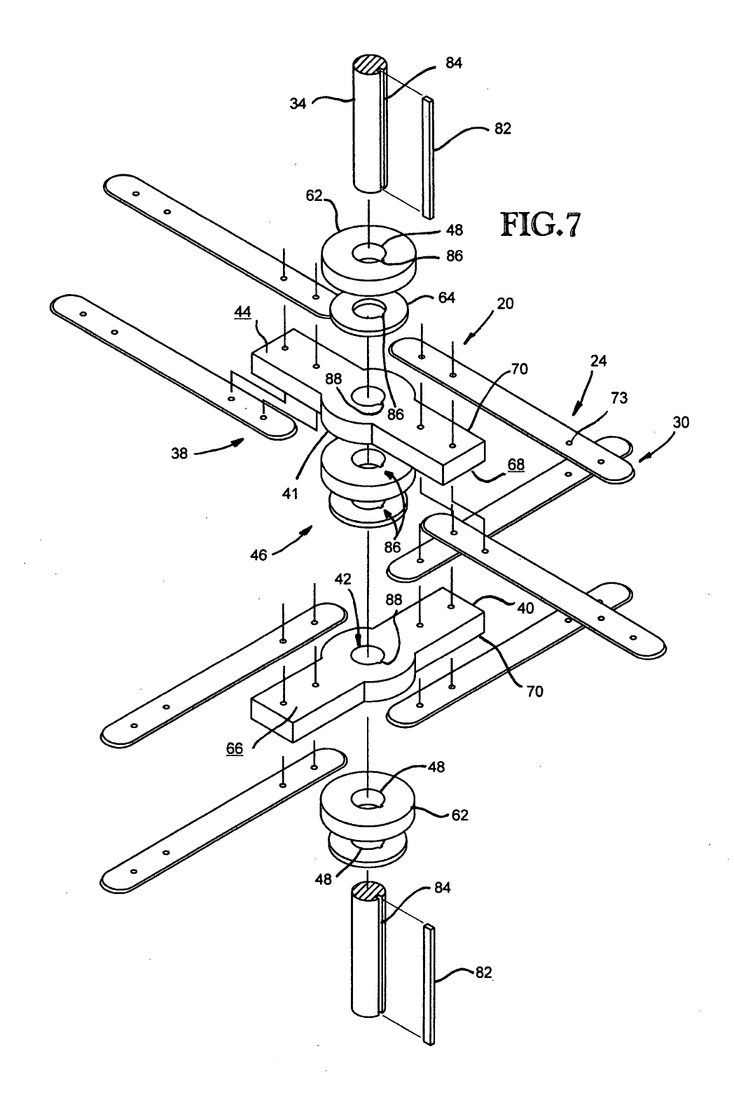

Directing attention now to FIG. 7, another, feature of the present invention is illustrated where each blade hub 40 is formed to define opposing mounting arms 70 symmetrically disposed on either side of the centrally located bore 42 through the blade hub 40. Each mounting arm 70 is so provided to receive the supported end 28 of at least one blade 24. Additionally, as illustrated in FIGS. 2 and 3, the blades 24 of present invention are secured to a mounting arm 70 by two removable fasteners, i.e., a nut and bolt type fastener.

Moreover, FIG. 7 illustrates the relative position of adjacent blade hubs 40. As illustrated, adjacent blade hubs 40 are rotated 90 degrees relative to the other, thereby positioning the blades 24, secured thereto, at right angles. In this way, blades 24 are more consistently entering the cutting zone 56 as the first and second blade columns 22, 32 are rotated.

Turning now to FIGS. 2 and 3, the first and second blade columns 22, 32 are illustrated to show that the lowest spacer member is secured on a shoulder 74 formed on the respective shaft 34 which provides a blade column seat 80. Notably, the lowest spacer member of the first blade column 22 is a deep spacer member 76 as opposed to the thin spacer member 78 of the second blade column 32. For this purpose, all the blades 24 of the first blade column 22 are vertically offset to prevent interference between the blades 24 of the first and second blade column 22, 32 as the same are rotated during the operation of the material processor 10. As will be seen below, the blade column seat 80 is formed by a portion, i.e., bearing spacer 93 of a lower bearing 92.

In addition, a shoulder 74 is formed on the shaft 34 above a section thereof defining a journal 90 that is received into a common lower bearing 92. The lower bearing 92 is secured in place by structural members 94 which are integral with, and part of the drum housing 14.

Likewise, the top portion of the shaft 34 defines an upper journal 96 that is receives into an upper bearing 98. The upper bearing is secured into place by upper structural members 100 which are also integral with, and part of the drum housing 14.

It should be noted that all spacer members 46, and blade assemblies 38 of the first and second blade columns 22, 32 are secured, against relative rotational movement, to a respective shaft 34 by a key 82 disposed in a shaft keyway 84 formed along the shaft 34. Specifically, the spacer members 46 include a spacer keyway 86 formed in the bore 48 of the spacer members 46, and likewise, a blade hub keyway 88 is formed along the bore 42 of blade hub 40.

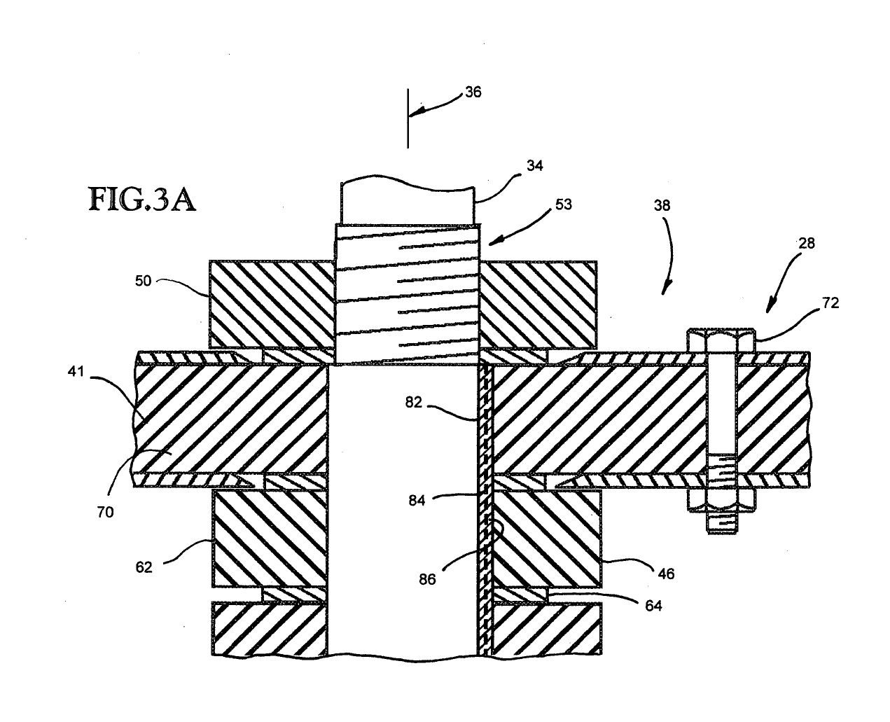

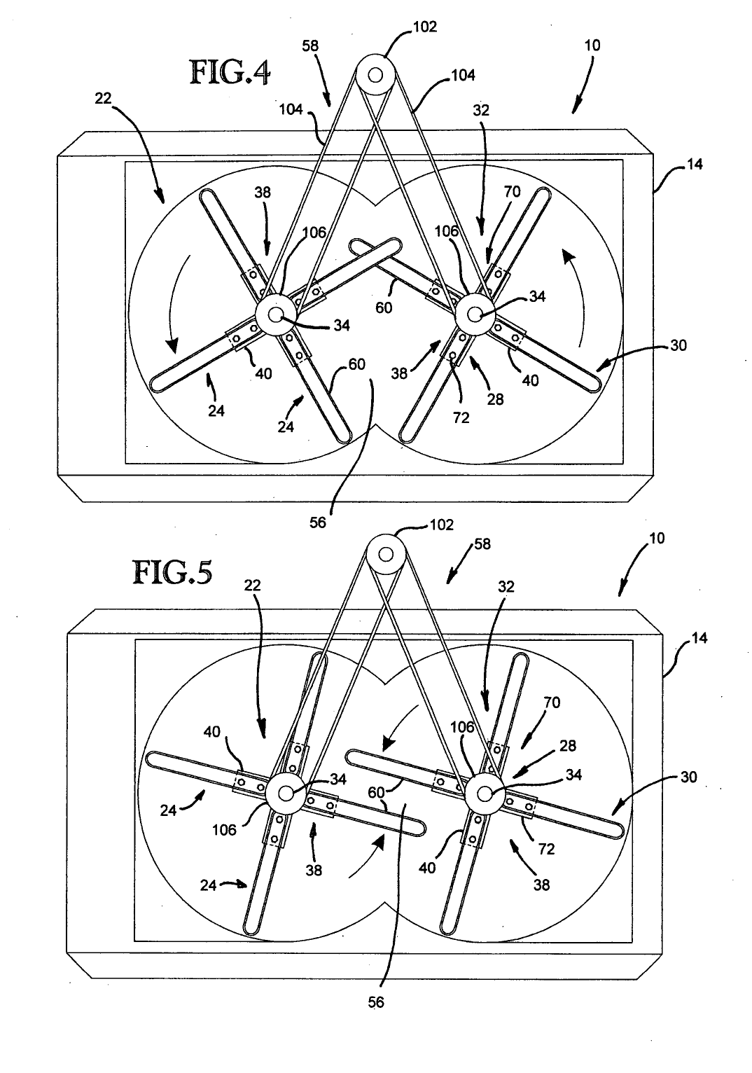

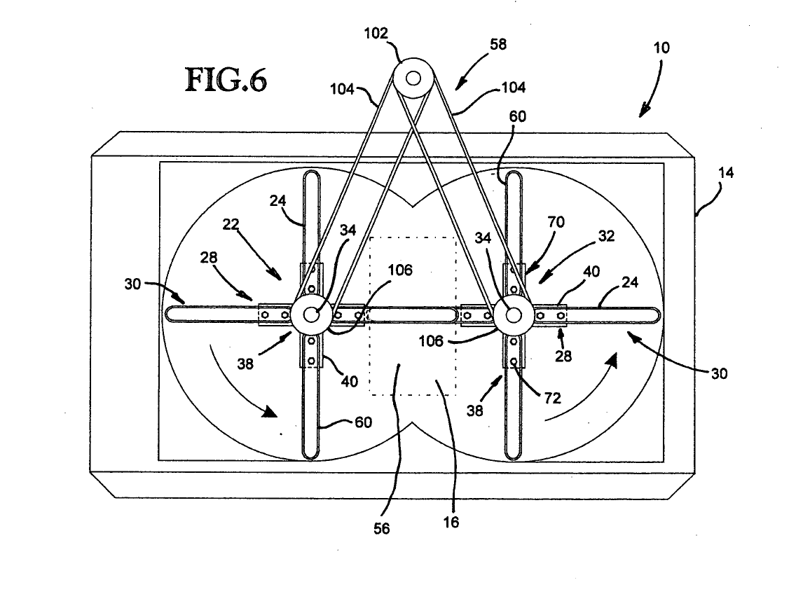

Turning now to FIGS. 4 through 6, an embodiment of the present invention comprises a drive mechanism 58 that includes a single electrically activated motor (not illustrated) that is connected to the blade columns 22, 32 via a drive pulley 102 turning two drive belts 104 that are connected respectively to a shaft pulley 106. In this way, each blade column is rotated at substantially the same revolutions per given time period.

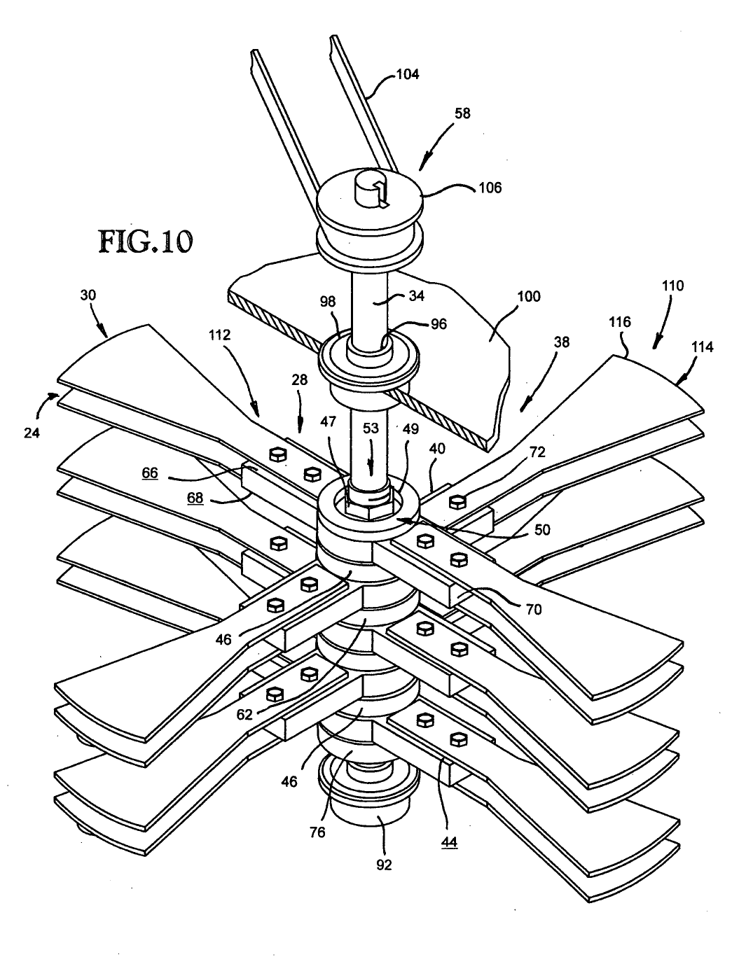

Finally, directing attention to FIG. 10, another embodiment is illustrated showing a expanded blade 110 having a tapered connection end 112 leading outward to an expanded end 114. In addition, the expanded end 114 thereof is shaped to have a rounded tip 116 to conform to the inside of the drum housing 14.

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

What is claimed is:

1. A material processor for cutting, breaking down and shredding waste construction materials to produce fibrous media for recycling the same, the material processor comprising:
a drum housing defining a top feed opening through which waste materials can pass through, into the drum housing, and a bottom exit opening through which processed waste material can exit;
first and second spaced apart blade columns vertically disposed and rotatably supported by the drum housing, each blade column comprising:
a vertically oriented shaft disposed to define a vertical axis;
a plurality of blade assemblies disposed in vertical stacked relationship, each blade assembly having a blade hub and at least one set of opposing planar blades, each blade hub defining a centrally located bore provided to enable co-axial mounting of each individual blade hub on a respective shaft, in vertical spaced relationship, each blade hub having a substantially horizontal mounting surface disposed about the centrally located bore, with each blade having a supported end mounted to the mounting surface, wherein each blade extends outward from the blade hub, disposed so that the horizontal center of gravity of each blade assembly lies substantially at the axis of the bore;
a plurality of spacer members, each spacer member being symmetrically formed to define a bore provided to enable co-axial mounting of the individual spacer members on the respective shaft so that each blade assembly is separated from an adjacent blade assembly by at least one spacer member;
means for preventing relative rotation between the blade assemblies and the shaft that it is mounted on;
means for vertically offsetting the blade assemblies on one shaft relative to the blade assemblies of an adjacent shaft;
the vertical axis of the first blade column being horizontally spaced apart from the vertical axis of the second blade column to define a vertical plane disposed between the blade columns where the blades of the first blade column horizontally overlap the blades of the second blade column to create a cutting zone disposed between the first and second blade columns as the blade columns rotate about their respective axes; and
a drive mechanism arranged and engaged to rotate the first and second blade columns about their respective vertical axes in the same rotational direction so that, as the blades enter the cutting zone, the leading edge of the blades of the first blade column rotate in a direction counter to the direction of rotation the leading edge of the blades of the second blade column.

2. A material processor as recited in claim 1 wherein the drum housing includes an upper bearing and a lower bearing for each shaft of each blade column, wherein each upper and lower bearing rotatably receives a portion of a respective shaft to rotatably secure the same within the drum housing, and wherein each lower bearing forms a shoulder adjacent the respective shaft to provide a blade column seat for rotatably supporting the respective blade column.

3. A material processor as recited in claim 2 wherein, at least one blade column includes a base spacer disposed to rest on the blade column seat, to enable an adjacent blade column, and the blades thereof, to be vertically offset.

4. A material processor as recited in claim 2 wherein, each blade column includes a base spacer disposed to rest on a respective blade column seat, each base spacer being of a dissimilar thickness to enable the blades of the adjacent blade columns to be vertically offset.

5. A material processor as recited in claim 1 wherein at least three spacer members are disposed between each blade assembly, wherein at least one of the spacer members comprises a dissimilar thickness.

6. A material processor as recited in claim 1 wherein each blade hub comprises an upper mounting surface for receiving a set of blades, and a lower mounting surface disposed to receive a second set of blades, wherein the centrally located bore extends from the upper mounting surface to the lower mounting surface.

7. A material processor as recited in claim 1 wherein each blade hub comprises opposing mounting arms symmetrically disposed on either side of the centrally located bore through the blade hub, each mounting arm provided to receive and support the supported end of at least one blade.

8. A material processor as recited in claim 7 wherein the secured relative position of each successive blade hub on each respective shaft is rotated by 90 degrees thereby rotationally off-setting the mounting arm of each successive blade hub by 90 degrees.

9. A material processor as recited in claim 8 further comprising a nut disposed over a top spacer disposed on top of the highest blade assembly of each blade column, the nut threadedly engaging the respective vertically oriented shaft to secure and urge together the blade assemblies and spacer members of each blade column.

10. A material processor as recited in claim 1 further comprising an elongate key structure partially disposed within a key slot formed along each vertical shaft, wherein the bore of each blade hub, and each spacer member includes a keyway so that the key fits between the same and the shaft.

11. A method for making a material processor for cutting, breaking down and shredding waste construction materials to produce fibrous media for recycling the same, comprising the steps:
forming a drum housing to define a top feed opening through which waste materials can pass through, into the drum housing, and a bottom exit opening through which processed waste material can exit;
rotatably supporting first and second spaced apart blade columns within the drum housing so that they are vertically disposed, the construction of each blade column comprising the steps:
orienting a vertical shaft to define a vertical axis;
installing a plurality of blade assemblies disposed in vertical stacked relationship, each blade assembly having a blade hub and at least one set of opposing planar blades, each blade hub defining a centrally located bore provided to enable co-axial mounting of each individual blade hub on a respective shaft, in vertical spaced relationship, each blade hub having a substantially horizontal mounting surface disposed about the centrally located bore, with each blade having a supported end mounted to the mounting surface, wherein each blade extends outward from the blade hub, disposed so that the horizontal center of gravity of each blade assembly lies substantially at the axis of the bore;
installing a plurality of spacer members, each spacer member being symmetrically formed to define a bore provided to enable co-axial mounting of the individual spacer members on the respective shaft so that each blade assembly is separated from an adjacent blade assembly by at least one spacer member;
providing means for preventing relative-rotation between the blade assemblies and the shaft that it is mounted on;
providing means for vertically offsetting the blade assemblies on one shaft relative to the blade assemblies of an adjacent shaft;
spacing the blade columns so that the vertical axis of the first blade column is horizontally spaced apart from the vertical axis of the second blade column to define a vertical plane disposed between the blade columns where the blades of the first blade column horizontally overlap the blades of the second blade column to create a cutting zone disposed between the first and second blade columns as the blade columns rotate about their respective axes; and
engaging a drive mechanism arranged to rotate the first and second blade columns about their respective vertical axes in the same rotational direction so that, as the blades enter the cutting zone, the leading edge of the blades of the first blade column rotate in a direction counter to the direction of rotation the leading edge of the blades of the second blade column.

12. A method of making material processor as recited in claim 1 wherein the drum housing includes an upper bearing and a lower bearing for each shaft of each blade column, wherein each upper and lower bearing rotatably receives a portion of a respective shaft to rotatably secure the same within the drum housing, and wherein each lower bearing forms a shoulder adjacent the respective shaft to provide a blade column seat for rotatably supporting the respective blade column.

13. A method of making a material processor as recited in claim 12 wherein, at least one blade column includes a base spacer disposed to rest on the blade column seat, to enable an adjacent blade column, and the blades thereof, to be vertically offset.

14. A method of making material processor as recited in claim 12 wherein, each blade column includes a base spacer disposed to rest on a respective blade column seat, each base spacer being of a dissimilar thickness to enable the blades of the adjacent blade columns to be vertically offset.

15. A method of making material processor as recited in claim 11 wherein at least three spacer members are disposed between each blade assembly, wherein at least one of the spacer members comprises a dissimilar thickness.
